(19) United States
(12) Patent Application Publication
(10) Pub. No.: US 2024/0426146 A1
(43) Pub. Date: Dec. 26, 2024

(54) VEHICLE DOOR HANDLE ASSEMBLY

(71) Applicant: MINEBEA ACCESSSOLUTIONS ITALIA S.P.A., Pianezza (IT)

(72) Inventors: Marco SAVANT, Pianezza (IT); Alberto GRAMAGLIA, Pianezza (IT); Alexandre PIERI, Pianezza (IT)

(73) Assignee: MINEBEA ACCESSSOLUTIONS ITALIA S.P.A., Pianezza (IT)

(21) Appl. No.: 18/746,147

(22) Filed: Jun. 18, 2024

(30) Foreign Application Priority Data
Jun. 21, 2023 (EP) 23180515.1

(51) Int. Cl. E05B 81/76; E05B 79/20; E05B 81/04; E05B 85/16

(52) U.S. Cl. CPC E05B 81/76; E05B 79/20; E05B 81/04; E05B 85/16

(57) ABSTRACT

A vehicle door handle assembly includes a movable lever arranged on an inner side of a vehicle door for rotating from a rest position to an active position, an electrical latch for opening the door, and a converter for converting a displacement of the movable lever toward the active position into an electrical opening signal sent to the electrical latch. The converter includes a housing forming a recess, a switch arranged in the recess and connected to the electrical latch, a movable part arranged in the recess for moving from a rest position associated with a first state of the switch wherein no signal is sent to an active position associated with a second state of the switch wherein an electrical opening signal is sent to the electrical latch, an elastic element, and a mechanical link arranged between the movable lever and the movable part.

### TECHNICAL FIELD

The present invention relates to the field of vehicle door handles to control the opening of vehicle doors and in particular to an inner door handle assembly.

### BACKGROUND OF THE INVENTION

In order to improve the security of the vehicle, the mechanical latches are more and more replaced by electrical latches wherein the door is opened upon reception of an electrical signal.

However, it may be very expensive to completely redesign the vehicle door to provide an electrical opening mechanism.

The present invention aims therefore at providing a vehicle door handle assembly wherein the displacement of a mechanical handle is converted into an electrical opening signal adapted to be transmitted to an electrical latch.

### SUMMARY OF THE INVENTION

The present invention refers to a vehicle door handle assembly comprising:
a movable lever arranged on an inner side of a vehicle door and configured for rotating from a rest position to an active position,
an electrical latch configured for opening the door upon reception of an electrical opening signal,
a converter configured for converting a displacement of the movable lever toward the active position into an electrical opening signal sent to the electrical latch, wherein the converter comprises:
a housing forming a recess,
a switch arranged in the recess and linked to the electrical latch,
a movable part arranged in the recess and configured for moving from a rest position associated with a first state of the switch wherein no signal is sent to an active position associated with a second state of the switch wherein an electrical opening signal is sent to the electrical latch,
an elastic element configured for constraining the movable part in the rest position,
a mechanical link arranged between the movable lever and the movable part.

The use of a converter configured for converting a displacement of the movable lever toward the active position into an electrical opening signal sent to the electrical latch enables keeping a mechanical handle usable with mechanical latches and use it in a door having an electric latch avoiding therefore a complete redesign of the vehicle door.

According to another aspect of the present invention, the mechanical link is a Bowden cable or a connecting rod.

According to another aspect of the present invention, the movable part is configured for translating between the rest position and the active position.

According to another aspect of the present invention, the movable part in configured for rotating between the rest position and the active position.

According to another aspect of the present invention, the elastic element is a helicoidal spring.

According to another aspect of the present invention, the switch is linked to the electrical latch by an electrical cable.

According to another aspect of the present invention, the electrical latch is located remotely with respect to the converter.

The present invention also refers to a vehicle door comprising a vehicle door handle assembly as described previously.

The present invention also refers to a vehicle comprising a vehicle door as described previously.

### BRIEF DESCRIPTION OF THE DRAWINGS

FIG. 1a is a door handle mechanism according to an embodiment of the present invention in a close position;

FIG. 1b is a door handle mechanism according to an embodiment of the present invention in an open position;

FIG. 2 is an exploded view of a converter according to an embodiment of the present invention;

FIG. 3 shows two states of the converter of FIG. 2;

FIG. 4 shows two states of a converter according to another embodiment of the present invention;

FIG. 5 is an exploded view of the converter of FIG. 4;

### DETAILED DESCRIPTION OF THE INVENTION

The following achievements are examples. Although, the specification refers to one or several embodiments, it does not imply that each reference refers to the same embodiment or that the features apply only to a single embodiment. Simple features of different embodiments can also be combined to provide other embodiments.

In the following of the description, the terms up, upper, low, lower, vertical, horizontal refers to relative positions or directions when the door handle is assembled to a vehicle.

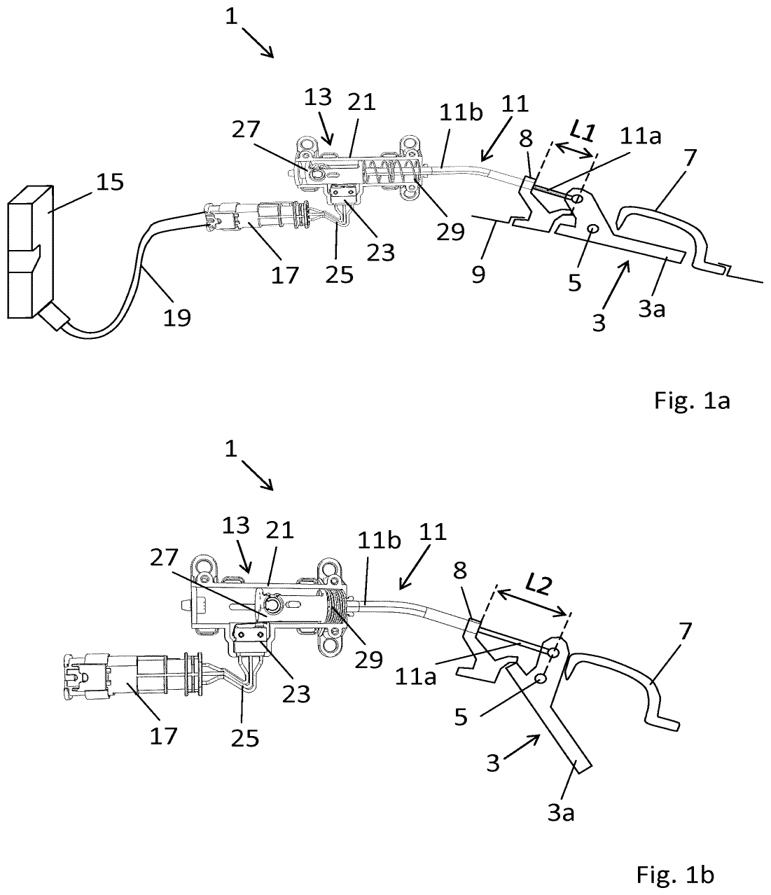

The present invention refers to a vehicle door handle assembly 1 and in particular an inner door handle. As represented in FIG. 1a, the vehicle door assembly comprises a movable lever 3 arranged on an inner side of a vehicle door. The lever 3 is for example a rotatable lever arranged for rotating around a pivot axis 5. The lever 3 is located within a recess of a casing 7 fixed to the inner door panel 9. The lever 3 comprises a handling part 3a at a first end located on a first side of the pivot axis 5. The handling part 3a is configured for being grabbed by a user in order to pull the handling part 3a of the lever 3 toward the interior of the car to open the door. The lever 3 also comprises an actuation part 3b at a second end of the lever 3 located on a second side of the pivot axis 5 opposed to the first side. The actuation part 3b is linked to a Bowden strand 11a of a Bowden cable 11 arranged between the casing 7 and a converter 13. The Bowden cable 11 comprises a sheath 11b connected on one side to a housing 21 of the converter 13 and on the other side to a stop 8 arranged in the casing 7. The actuation part 3b of the lever 3 may be remote to the stop 8 with a rest corresponding to the length L1 when the lever 3 is in a rest position (corresponding to the position represented in FIG. 1a). When the user pulls on the lever 3, the said lever 3 is configured for pivoting from the rest position to an active position (corresponding to the position represented in FIG. 1b). The actuation part 3b is then displaced away from the stop 8 to a length L2 corresponding to the stroke of the actuation part 3b of the lever 3. Alternatively, the Bowden cable 11 may be replaced by a connecting rod or any other suitable mechanical link.

The vehicle door handle assembly 1 also comprises an electrical latch 15. The electrical latch 15 is configured for opening the door upon reception of an electrical opening signal. The electrical latch 15 may be arranged in a remote position with respect to the lever 3, for example in a different part of the door. The electrical latch 15 may be connected to an electrical connector 17 of the converter via an electrical cable 19. The electrical connector 17 is optional.

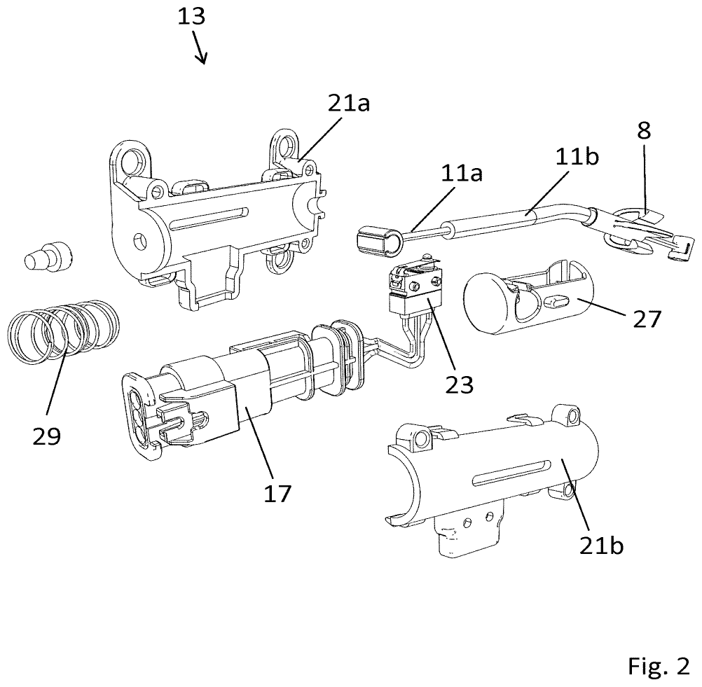

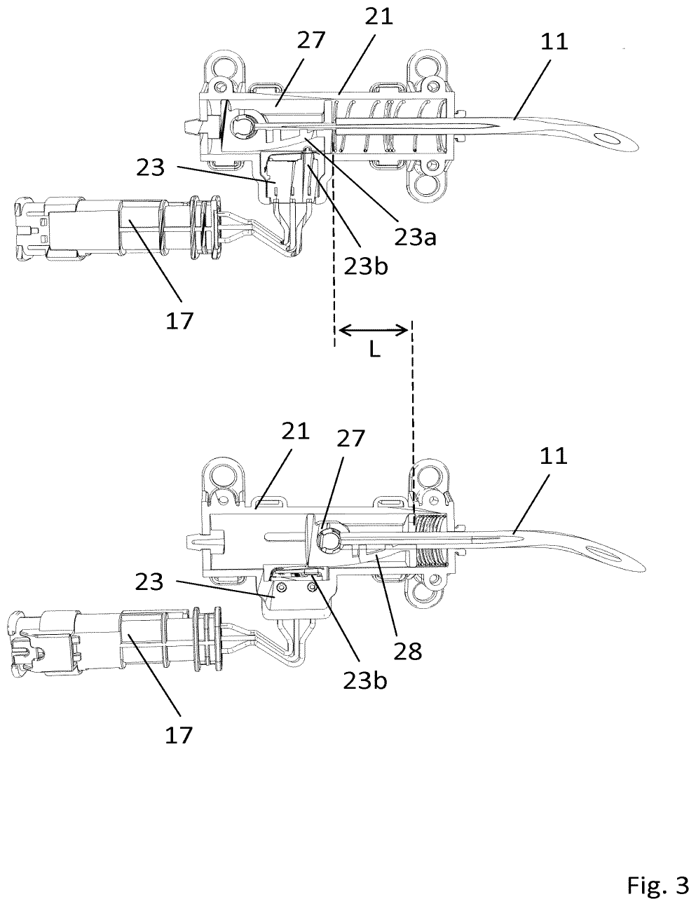

The converter 13 comprises a hollow housing 21 forming an internal recess. The housing may have a cylindrical shape and can be made of two half cylindrical shells 21a and 21b as represented in the exploded view of the converter 13 in FIG. 2. The shells can be fastened together, for example by clipping. The internal recess may also have a cylindrical shape. The converter 13 also comprises a switch 23 arranged in the recess and connected to the electrical connector 17 via an electrical cable 25. The converter 13 also comprises a movable part 27 arranged in the recess. The movable part 27 is linked to the end of the cable strand 11a opposite to the end linked to the lever 3 so that the cable strand 11a provides a mechanical link between the movable lever 3 and the movable part 27. The movable part 27 may also have a cylindrical shape complementary with the shape of the internal recess. Alternatively, non-cylindrical shapes may be used for the recess and the movable part 27 to prevent the movable part 27 from rotating within the recess leading to a twist of the cable strand 11a. The movable part 27 is configured for translating in the recess from a rest position associated with the rest position of the lever 3 to an active position associated with the active position of the lever 3. Furthermore, when passing from the rest position to the active position, the movable part is configured for switching the switch 23 from a first state wherein no signal is sent to a second state wherein an electrical opening signal is sent to the electrical latch 15. The switch 23 comprises for example a lever 23a (visible in FIG. 3) which is pushed down by the movable part 27 to come into contact with an electrical contact 23b leading to the transmission of an electrical opening signal sent to the electrical latch 15 via the electrical cable 25, the connector 17 and the electrical cable 19. The movable part 27 may comprise a bevelled shape 28 as represented in FIG. 3. The bevelled shape 28 provides a space for the lever 23a to move up and away from the electrical contact 23b when the movable part 27 is in the rest position and will push down the lever 23a to come into contact with the electrical contact 23b when the movable part 27 is moved to the active position.

The converter 13 also comprises an elastic element 29 such as a helicoidal spring configured for constraining the movable part 27 toward the rest position. In particular, the elastic element 29 is configured to bring the movable part 27 back from the active position to the rest position when the user releases the lever 3. The elastic element 29 may also be configured to bring the lever 3 back in the rest position (but another elastic element may be dedicated to the lever 3). Thus, when the user pulls the handling part 3a of the movable lever 3 from the rest position to the active position, the movable lever 3 is rotated around the pivot axis 5 so that the cable strand 11a is pulled of a length L=L2−L1 leading to the displacement of the movable part 27 from its rest position to its active position in the housing 21 and the compression of the elastic element 29. The displacement of the movable part 27 towards the active position leads to the switching of the switch 23 to the second state and therefore to the transmission of an electrical opening signal toward the electrical latch 15 so that the door is opened. When the user releases the lever 3, the elastic element 29 (possibly with the help of another elastic mean associated with the lever 3) stretches out and brings the movable part 27 back in the rest position. Simultaneously, the lever 3 is brought back into its rest position.

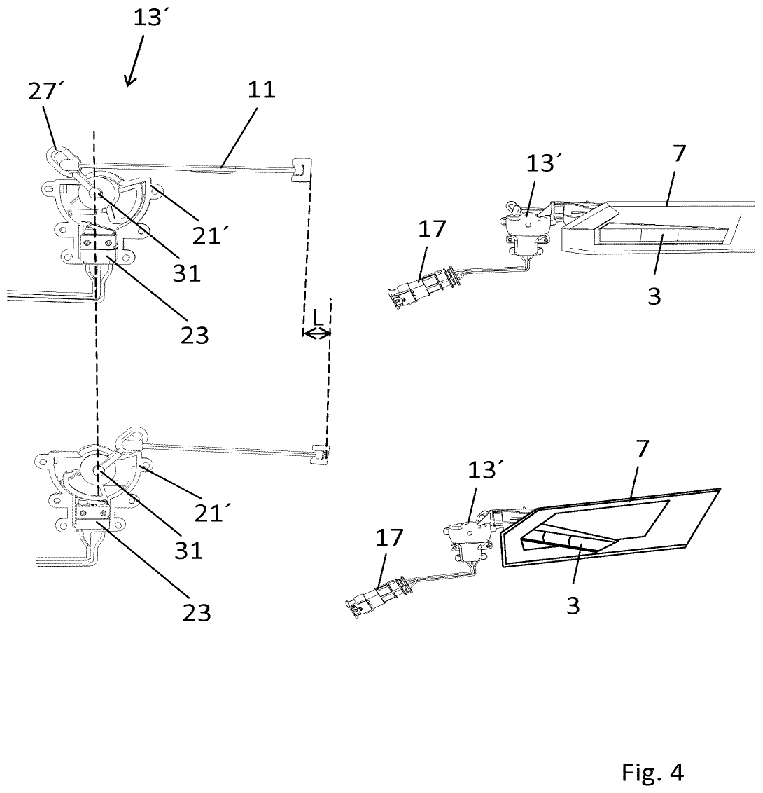

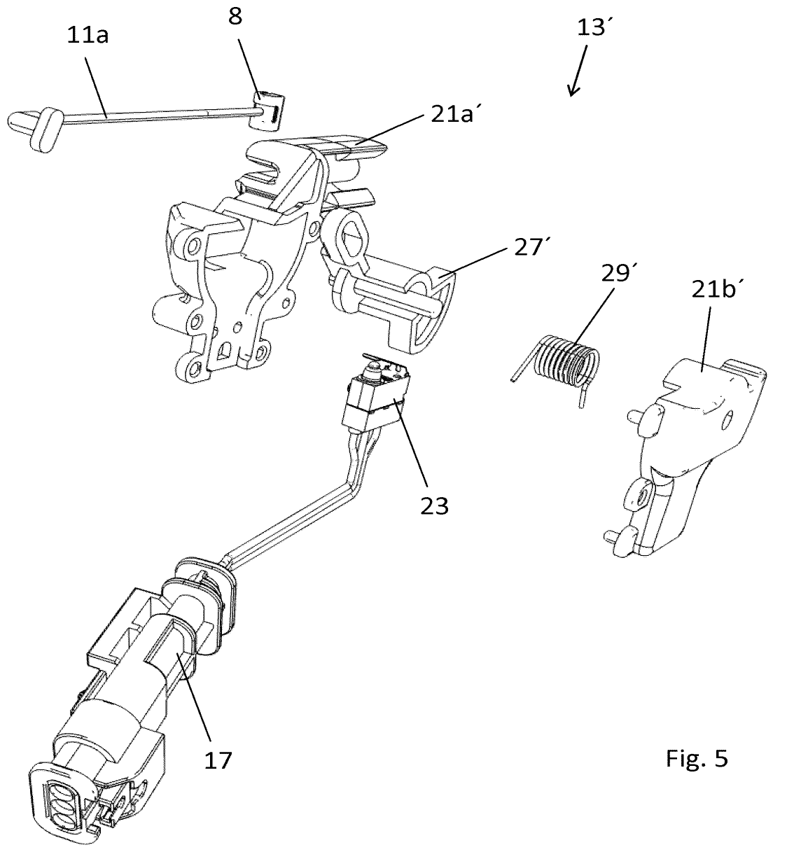

The use of a converter configured to convert the movement of a cable linked to the handle lever 3 into an electrical opening signal enables using a handle lever of a mechanical handle mechanism in an electrical opening door without modifying the design of the handle lever 3. FIGS. 4 and 5 represent another embodiment wherein the movable part 27′ is configured for rotating within the recess of the housing 21′ of the converter 13′. Furthermore, the converter 13′ of this embodiment is less bulky and can be positioned next to the casing 7 so that no cable sheath is needed. The movable part 27′ is configured to rotate from a rest position represented in the upper part of FIG. 4 to an active position represented in the lower part of FIG. 4 upon the action of the Bowden strand 11 when the lever 3 is pulled by the user. The converter 13′ may comprise a pivot axis 31 and the movable part 27′ may be configured to rotate around said pivot axis 31. The movable part 27′ may comprise a first extension 27′a located on a first side of the pivot axis 31 which is and linked to the Bowden strand 11 and a second extension 27′b located on a second side of the pivot axis 31 opposite to the first side and configured to push down the lever 23a of the switch 23 to trig the transmission of an electrical opening signal when the movable part 27 moves toward the active position. The converter also comprises an elastic element 29′ (more visible in the exploded view of FIG. 5) such as a spring to bring the movable part 27′ back in the rest position. The housing 21′ of the converter 13′ may also comprise two shells 21a′ and 21b′ fastened together, for example by clipping. The other aspects of this second embodiment may be similar to the first embodiment described previously in FIGS. 1a to 3.

Thus, when the user pulls the handling part 3a of the movable lever 3 from the rest position to the active position, the movable lever 3 is rotated around the pivot axis 5 so that the cable strand 11a is pulled of a length L leading to the rotation of the movable part 27′ from its rest position to its active position in the housing 21′ and the tension of the elastic element 29′. The rotation of the movable part 27′ towards the active position leads to the switching of the switch 23 to the second state and therefore to the transmission of an electrical opening signal toward the electrical latch 15 so that the door is opened. When the user releases the lever 3, the elastic element 29′ (possibly with the help of another elastic mean associated with the lever 3) is brought back in its released state and brings the movable part 27′ back in the rest position. Simultaneously, the lever 3 is brought back into its rest position.

Thus, the present invention provides a way to adapt an existing mechanical door handle to an electric door opening mechanism in order to avoid redesigning completely the door to provide an electrical opening.

1-9. (canceled)

10. A vehicle door handle assembly comprising:
a movable lever arranged on an inner side of a vehicle door and configured to be rotated from a rest position to an active position;
an electrical latch configured to open the door upon reception of an electrical opening signal; and
a converter configured to convert a displacement of the movable lever toward the active position into an electrical opening signal sent to the electrical latch,
wherein the converter comprises:
a housing forming a recess,
a switch arranged in the recess and connected to the electrical latch,
a movable part arranged in the recess and configured to move from a rest position associated with a first state of the switch wherein no signal is sent to an active position associated with a second state of the switch wherein an electrical opening signal is sent to the electrical latch,
an elastic element configured to constrain the movable part in the rest position, and
a mechanical link arranged between the movable lever and the movable part.

11. The vehicle door handle assembly in accordance with claim 10, wherein the mechanical link is a Bowden cable or a connecting rod.

12. The vehicle door handle assembly in accordance with claim 10, wherein the movable part is configured to translate between the rest position and the active position.

13. The vehicle door handle assembly in accordance with claim 10, wherein the movable part in configured to rotate between the rest position and the active position.

14. The vehicle door handle assembly in accordance with claim 10, wherein the elastic element is a helicoidal spring.

15. The vehicle door handle assembly in accordance with claim 10, wherein the switch is linked to the electrical latch by an electrical cable.

16. The vehicle door handle assembly in accordance with claim 10, wherein the electrical latch is located remotely with respect to the converter.

17. A vehicle door comprising:
the vehicle door handle assembly in accordance with claim 10.

18. A vehicle comprising:
the vehicle door in accordance with claim 17.
